(19) United States
(12) Patent Application Publication
(10) Pub. No.: US 2003/0196001 A1
(43) Pub. Date: Oct. 16, 2003

(54) Digital signed document delivery system, digital signed document delivery method, digital signed document delivery program, and recording medium in which the digital signed document delivery program is recorded

(76) Inventor: Ryuji Nagahama, Tokyo (JP)

Correspondence Address: BIRCH STEWART KOLASCH & BIRCH, PO BOX 747, FALLS CHURCH, VA, 22040-0747, US

(21) Appl. No.: 10/387,559

(22) Filed: Mar. 14, 2003

(30) Foreign Application Priority Data
Apr. 12, 2002 (JP) 2002-110544
Dec. 26, 2002 (JP) 2002-377791

(51) Int. Cl. G06F 3/00

(52) U.S. Cl. 710/1

(57) ABSTRACT

In order to realize work load reduction and cost reduction, there is provided a system that includes a bill data creating unit (5) for creating bill creation data composed of character strings, a digital bill creating unit (6) for creating a digital bill using the bill creation data, a digital signature unit (7) for creating digital signature data by performing digital signature processing on the created digital bill, and a bill electronic delivery unit (9) for combining the digital bill and the digital signature data and electronically delivering them. Among these construction elements, the digital bill creating unit (6) and the digital signature unit (7) are provided in a server (20) and the bill creation processing and the digital signature processing are automatically performed by the server (20) without the requirement for operations from an operator.

### BACKGROUND OF THE INVENTION

1. Field of the Invention

The present invention relates to a digital signed document delivery system, a digital signed document delivery method, and a digital signed document delivery program for placing a digital signature on a digital document and delivering the digital signed document. The present invention also relates to a recording medium in which the digital signed document delivery program is recorded.

2. Description of the Related Art

In FIGS. 12 and 13, there is shown a conventional method of issuing and receiving various kinds of documents such as a bill (debit note) and a contract document. In these drawings, reference numeral 101 denotes a document issuing section in which a document, such as a bill or a contract document, is issued using a computer, a word processing apparatus, or the like. Reference numeral 102 indicates a document printing section in which the document issued in the document issuing section 101 is printed using a printer or the like. Reference numeral 103 represents a document seal affixing work section in which a bill issuer manually affixes a seal or a signature on the document obtained through printing on a paper medium in the document printing section 102. Reference numeral 104 denotes a document dispatching work section in which the sealed or signed document is manually folded to a predetermined size, the folded document is put in an envelope, a postage stamp is affixed on the envelope, and the sealed or signed document is dispatched from a post office or a mailbox. Reference numeral 105 indicates a mailing work section in which the sealed or signed document dispatched in the document dispatching work section 104 is mailed. Reference numeral 106 represents a document receiving work section that is a mailbox or a bill recipient himself/herself that receives the sealed or signed document mailed in the document mailing work section 105. Reference numeral 107 denotes a document processing section in which processing for formalities is performed based on the sealed or signed document received in the document receiving work section 106.

Next, an operation that has conventionally been performed to issue a bill will be described with reference to FIG. 14. Under present circumstances, it is generally required to place a seal or a signature on a bill, so that the bill is exchanged in a paper form. On a side on which the bill will be dispatched, the issuance, sealing, and dispatching of the bill are performed by the bill issuer for each of a plurality of bill recipients. The bill is processed in the paper form, so that there are performed many manual works, as described above.

In a like manner, it is also required to place a seal or a signature on a contract document, so that under present circumstances, the contract document is also generally exchanged in a paper form. Processing performed when a contract document is received will be described with reference to FIG. 15. Contract documents are forwarded from a plurality of companies with which a recipient thereof contracts, and reception and confirmation of the contract documents are manually performed in many cases because the contact documents are mailed in a paper form.

As described above, with the conventional methods, generally, a document, such as a bill or a contact document, that requires a seal or a signature is first created with a computer or the like, is then printed on paper with a printer or the like, and is finally forwarded by mail. However, the document takes a paper form, so that it is impossible to automatically perform these works through mechanization and most of works for affixing a seal to the document, putting the sealed document into an envelope, affixing a postage stamp to the envelope, posting the envelope, mailing the envelope, and receiving the envelope are manually performed. Therefore, in the case where the number of documents to be dispatched becomes large (becomes several thousands, several ten thousands, or the like), there occurs a problem that many staffs are required and costs, such as envelope cost and mailing cost, are increased. Further, on the recipient side, in the case where it is hoped to use data written on the bill or contact document, there occurs a problem that it is required to manually input the data into a computer while glancing at the paper medium, that is, it is required to perform an inefficient work.

Also, in recent years, as the world moves toward a paperless society, there have been developed a digital seal affixing technique and a digital signature technique. Currently, however, in these systems under development, as shown in FIG. 16, a document, such as a bill or a contract document, is created on the screen of a computer, at least one signature area 110 is created for the document, and a signer affixes a digital seal 112 by designating the signature area corresponding to the signer using a mouse pointer 111 or the like. Therefore, although a computer is used to perform the seal affixing work, manual works, such as the operation of a mouse or the like by the signer, are still required and, in the case where the number of documents becomes large, there occurs a problem that the processing takes a long time and a considerably heavy load is placed on the signer.

Also, in this case, it is required to input required data into designated and predetermined spaces (input fields) of the document created in a structured document form, so that this input work also requires a troublesome operation. In addition, in the case where the number of documents becomes large, there occurs a problem that there is placed a considerably heavy load of the operation, like in the case described above.

### SUMMARY OF THE INVENTION

The present invention has been made in order to solve these problems and an object of the present invention is to provide a digital signed document delivery system, a digital signed document delivery method, and a digital signed document delivery program that achieve work load reduction and cost reduction. Another object of the present invention is to provide a recording medium in which the digital signed document delivery program is recorded.

The present invention provides a digital signed document delivery system including:

a document creation data input means for inputting document creation data composed of character strings;

a digital document creating means for creating a digital document using the document creation data;

a digital signature means for creating digital signature data by performing digital signature processing on the created digital document; and

a document delivery means for combining the digital document and the digital signature data and electronically delivering them.

Also, the digital signed document delivery system further includes:

a format data storage means for storing format data for creating the digital document,

wherein the digital document creating means creates the digital document based on the format data.

Also, the digital signed document delivery system further includes:

a verification program storage means in which a verification program that verifies the delivered digital signature data is stored,

wherein the verification program is provided to a recipient side through a communication network.

Also, in the digital signed document delivery system, the digital signature processing is performed using a predetermined secret key and a predetermined digital seal, and the secret key and the digital seal are stored in a tamper-resistant recording means.

Also, the digital signed document delivery system further includes:

a document receiving means for receiving the delivered digital document and digital signature data;

a verification means for verifying authenticity of the received digital signature data using the verification program;

a return document creating means for, if a result of the verification by the verification means is affirmative, creating a return digital document using the digital document;

a return digital signature means for creating return digital signature data by performing digital signature processing on the created return digital document; and

a document returning means for combining the return digital document and the return digital signature data and electronically delivering them.

Also, the digital signed document delivery system further includes:

a return document receiving means for receiving the delivered return digital document and return digital signature data; and

a verification means for verifying the received return digital signature data.

Also, the digital signed document delivery system according to the present invention includes:

at least one delivery means for combining a digital document and digital signature data obtained by performing digital signature processing on the digital document, and delivering them;

a receiving means for receiving the digital document and the digital signature data delivered by the delivery means;

a verification means for verifying the received digital signature data; and

a verification program storage means in which a verification program for performing the verification by the verification means is stored.

Also, the present invention provides a digital signed document delivery method including:

a document creation data input step of inputting document creation data composed of character strings;

a digital document creating step of creating a digital document using the document creation data;

a digital signature step of creating digital signature data by performing digital signature processing on the created digital document; and

a document delivery step of combining the digital document and the digital signature data and electronically delivering them.

Also, the present invention provides a digital signed document delivery method including:

at least one delivery step of combining a digital document and digital signature data obtained by performing digital signature processing on the digital document, and delivering them;

a receiving step of receiving the digital document and the digital signature data delivered by the delivery step;

a verification step of verifying the received digital signature data; and

a verification program storage step in which a verification program for performing the verification by the verification step is stored.

Also, the present invention provides a digital signed document delivery program used for allowing a computer to execute:

a document creation data input step of inputting document creation data composed of character strings;

a digital document creating step of creating a digital document using the document creation data;

a digital signature step of creating digital signature data by performing digital signature processing on the created digital document; and

a document delivery step of combining the digital document and the digital signature data and electronically delivering them.

Also, the present invention provides the digital signed document delivery program used for allowing a computer to execute:

at least one delivery step of combining a digital document and digital signature data obtained by performing digital signature processing on the digital document, and delivering them;

a receiving step of receiving the digital document and the digital signature data delivered by the delivery step;

a verification step of verifying the received digital signature data; and

a verification program storage step in which a verification program for performing the verification by the verification step is stored.

Also, the present invention provides a computer readable recording medium that records a digital signed document delivery program used for allowing a computer to execute:

a document creation data input step of inputting document creation data composed of character strings;

a digital document creating step of creating a digital document using the document creation data;

a digital signature step of creating digital signature data by performing digital signature processing on the created digital document; and

a document delivery step of combining the digital document and the digital signature data and electronically delivering them.

Also, the present invention provides the computer readable recording medium that records a digital signed document delivery program used for allowing a computer to execute:

at least one delivery step of combining a digital document and digital signature data obtained by performing digital signature processing on the digital document, and delivering them;

a receiving step of receiving the digital document and the digital signature data delivered by the delivery step;

a verification step of verifying the received digital signature data; and

a verification program storage step in which a verification program for performing the verification by the verification step is stored.

Also, the digital signed document delivery system according to the present invention further includes:

a data receiving unit that receives a digital document issuance request, digital document data concerning a digital document, and format data concerning the digital document from at least one digital document issuer, wherein:

the format data storage means stores the format data received by the data receiving unit as a format data file; and

the document creation data input means stores the digital document data received by the data receiving unit as a digital document data file.

### BRIEF DESCRIPTION OF THE DRAWINGS

In the accompanying drawings:

FIG. 1 is a block diagram showing a construction of a digital signed document delivery system according to a first embodiment of the present invention;

FIG. 2 is an explanatory drawing showing an outline of the digital signed document delivery system according to the first embodiment of the present invention;

FIG. 3 is an explanatory drawing showing an example of bill data created in a bill data creating unit provided in the digital signed document delivery system according to the first embodiment of the present invention;

FIG. 4 is an explanatory drawing showing an example of a digital bill created by a digital bill creating unit provided in the digital signed document delivery system according to the first embodiment of the present invention;

FIG. 5 is an explanatory drawing illustrating a principle of digital signature processing;

FIG. 6 is a flowchart showing the flow of processing performed in the digital signed document delivery system according to the first embodiment of the present invention;

FIG. 7 is a block diagram showing a construction of a digital signed document delivery system according to a second embodiment of the present invention;

FIG. 8 is an explanatory drawing showing an outline of the digital signed document delivery system according to the second embodiment of the present invention;

FIG. 9 is a flowchart showing the flow of processing performed in the digital signed document delivery system according to the second embodiment of the present invention;

FIG. 10 is a block diagram showing a construction of a digital signed document delivery system according to a third embodiment of the present invention;

FIG. 11 is an explanatory drawing showing an example of a digital estimation sheet created by a digital estimation sheet creating unit provided in the digital signed document delivery system according to the third embodiment of the present invention;

FIG. 12 is an explanatory drawing showing a conventional method of issuing and receiving a bill or a contract document;

FIG. 13 is another explanatory drawing showing the conventional method of issuing and receiving a bill or a contract document;

FIG. 14 is an explanatory drawing showing a conventional method of issuing and receiving bills;

FIG. 15 is an explanatory drawing showing a conventional method of issuing and receiving contract documents;

FIG. 16 is an explanatory drawing showing an example of a digital bill displayed on a screen of a conventional seal affixing system or digital signature placing system;

FIG. 17 is a block diagram showing a construction of a digital signed document delivery system according to a fourth embodiment of the present invention;

FIG. 18 is an explanatory drawing showing an outline of the digital signed document delivery system according to the fourth embodiment of the present invention;

FIG. 19 is a flowchart showing the flow of processing performed in the digital signed document delivery system according to the fourth embodiment of the present invention;

FIG. 20 is an explanatory drawing showing an outline of a digital signed document delivery system according to a fifth embodiment of the present invention; and

FIG. 21 is an explanatory drawing showing an outline of a digital signed document delivery system according to a sixth embodiment of the present invention.

### DETAILED DESCRIPTION OF THE PREFERRED EMBODIMENTS

(First Embodiment)

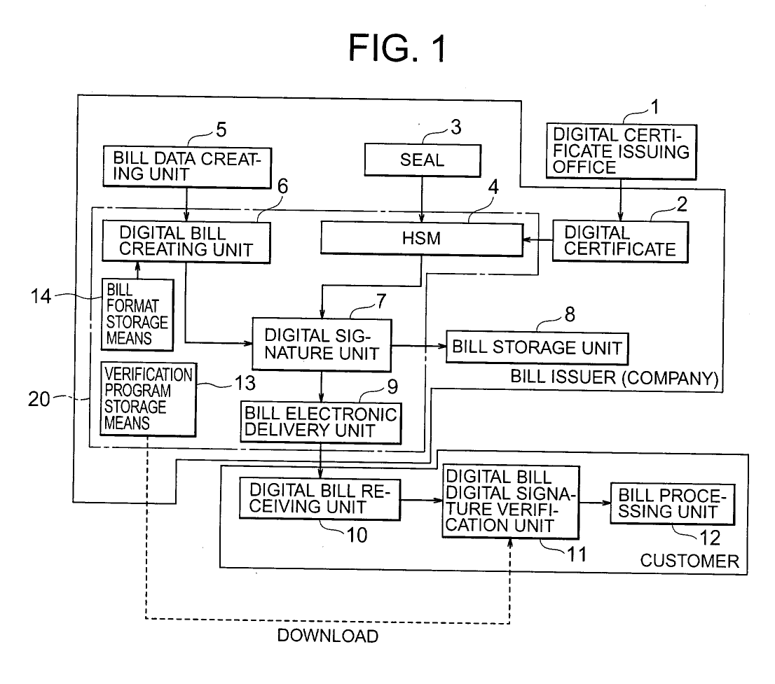

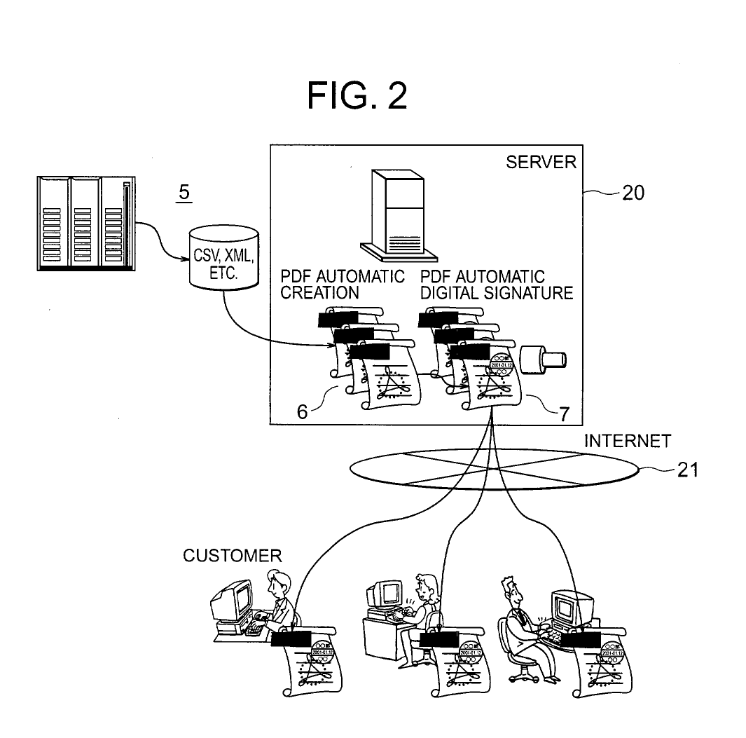

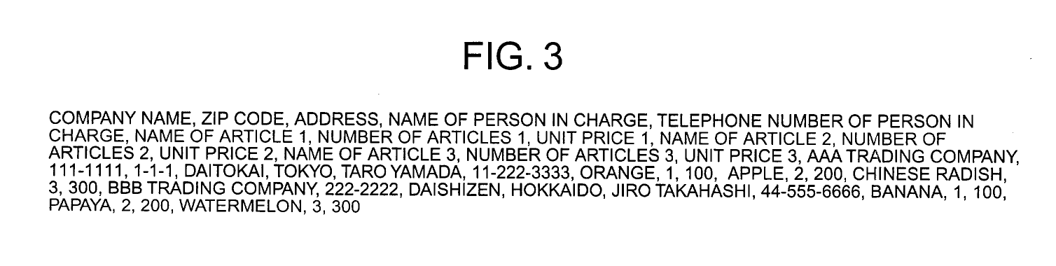

FIGS. 1 and 2 show the construction of a digital signed document delivery system according to a first embodiment of the present invention. In these drawings, a case where a bill is issued is illustrated as an example. Also, in these drawings, the same construction elements are given the same reference numerals for the sake of clarifying correspondences. In FIG. 1 (and in FIG. 2), reference numeral 1 denotes a digital certificate issuing office that issues a digital certificate and reference numeral 2 represents a digital certificate issued by the digital certificate issuing office 1. The digital certificate 2 contains a secret key to be applied to encryption performed at the time of digital signature processing and a public key certificate that certifies the authenticity of a public key paired with the secret key. Reference numeral 3 indicates a seal (or a digital seal, also referred to as the “seal data”) to be affixed to a digital document at the time of the digital signature processing. Reference numeral 4 denotes a tamper-resistant hardware security module (hereinafter abbreviated as the “HSM”) in which the digital certificate 2 and the seal data 3 are stored while maintaining a security level. This HSM is mounted in a server 20. Note that the term “tamper-resistant” means that the HSM has a construction where unauthorized internal analysis or alterations are impossible. Reference numeral 5 indicates a bill data creating unit that is constructed from one kind of computer, such as a trunk system, a work station, or a personal computer, and creates various kinds of data necessary for creation of a bill. In FIG. 3, there is shown an example of data created by the bill data creating unit 5. In this embodiment, as shown in FIG. 3, the data is composed of a plurality of character strings arranged in a predetermined order, and shows each kind of data necessary for the creation of a bill. In FIG. 3, the data is composed of “a company name, a zip code, an address, the name of a person in charge, the telephone number of the person in charge, the name of an article 1, the number of articles 1, a unit price 1, . . . ”. Here, these character strings are written using a computer language such as CSV or XML. In the case of CSV, for instance, the data is written as a set of character strings separated by commas (that is, “AAA trading company, 111-1111, 1-1-1, Daitokai, Tokyo, Taro Yamada, 11-222-3333, Orange, 1, 100, . . . ”). Note that although omitted in FIG. 3, the bill data also contains delivery destination information, such as a mail address of a customer, which becomes necessary at the time of electronic delivery of the bill.

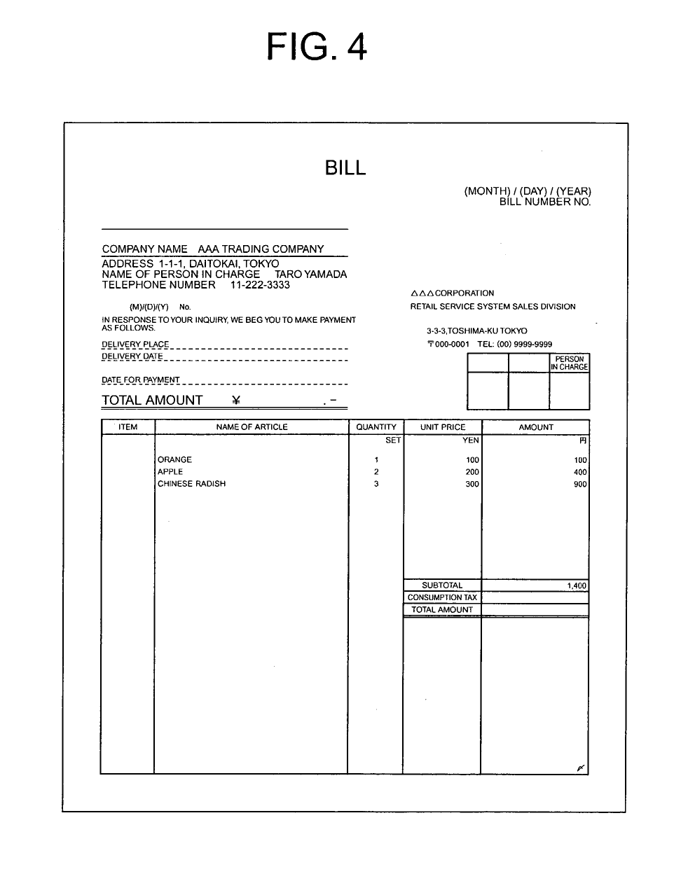

Also, in FIG. 1, reference numeral 6 indicates a digital bill creating unit that receives input of the data created by the bill data creating unit 5 and creates a digital bill using bill format data prestored in a bill format storage means 14 to be described later. An example of the digital bill created from the data shown in FIG. 3 is shown in FIG. 4. For instance, the digital bill is created as a PDF file. However, the present invention is not limited to this and the digital bill may be created as a Word document, an Excel document, or the like. Reference numeral 7 denotes a digital signature unit that performs digital signature processing by encrypting the digital bill created by the digital bill creating unit 6 using a secret key possessed by a signer. Reference numeral 8 indicates a bill storage unit in which the digital bill on which a digital signature has been placed in the digital signature unit 7 is stored, and reference numeral 9 represents a bill electronic delivery unit that electronically delivers (that is, by E-mail or over the Web) the digital bill on which the digital signature has been placed in the digital signature unit 7. Reference numeral 13 denotes a verification program storage means in which there is stored a verification program provided to a customer side through downloading at the time of verification of the digital bill. Also, reference numeral 14 indicates a bill format storage means in which there is stored bill format data used by the digital bill creating unit 6 to create the digital bill. The format data is inputted and stored in advance from a computer apparatus connected to the server 20 such as an operator-side terminal. At the time of creation of the digital bill, the digital bill creating unit 6 first reads this format data, inserts bill data into predetermined spaces of the format data in order, thereby creating the digital bill without the requirement for operations from an operator. Here, note that the digital bill creating unit 6, the digital signature unit 7, and the bill electronic delivery unit 9 are constructed from the server 20 and each function thereof is operated by control from the server 20, which means that no operation from the operator is required. Note that reference numerals 2 to 9 and 20 specify construction elements provided on a bill issuer side.

Also, in FIG. 1, reference numeral 10 denotes a digital bill receiving unit that receives the electronically signed and delivered digital bill on a customer side, numeral 11 a digital bill digital signature verifying unit that verifies the digital signature placed on the digital bill using the downloaded verification program, and numeral 12 a bill processing unit that performs bill processing based on the digital bill. Note that reference numerals 10, 11, and 12 specify construction elements provided on the customer side on which the bill is received.

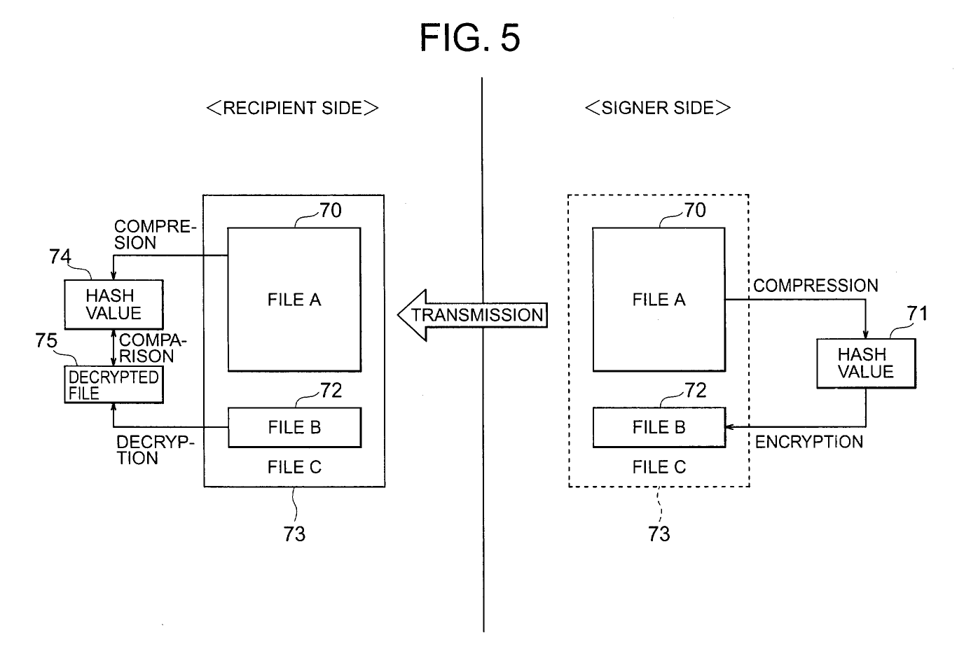

Here, the principle of the digital signature processing will be briefly described with reference to FIG. 5. First, there will be described an operation made by a signer. The signer creates a file A 70 that is a document on which his/her signature should be placed and performs compression processing on the file A 70 using a predetermined hash function, thereby creating a hash value 71. Next, the hash value 71 is encrypted using a secret key possessed by the signer, thereby creating a file B 72. This file B is called a digital signature or digital signature data. The signer combines the original file A 70 and the file B (digital signature) 72 to obtain a single file C 73 and transmits the file C 73 to a recipient side as a document on which a signature has been placed.

Next, an operation made by a recipient will be described. Upon receiving the file C 73 obtained by combining the file A70 and the file B (digital signature) 72, the recipient first extracts the file A 70 and performs compression processing on the file A 70 using the same hash function as that used by the signer to compress the file A 70, thereby generating a hash value 74. Next, the recipient extracts the file B (digital signature) 72 and decrypts the file B 72 using a public key possessed by the recipient (certified person), thereby creating a decrypted file 75. Next, the recipient compares the hash value 74 with the decrypted file 75. If the contents of them agree with each other, this certifies that the file A70 is surely signed by the signer himself/herself and is not tampered. Note that the aforementioned compression processing performed on the signer side and the recipient side are not necessarily required to be performed, and it does not matter whether the compression processing is omitted on both sides or is performed on both sides.

Also, there may be used another authentication method with which the signer attaches and transmits the digital certificate 2 at the time of transmission of the original document and the digital signature. In this method, the recipient downloads the verification program for executing the verification of the digital certificate 2 from the verification program storage means 13 of the server 20 through a communication network, such as the Internet, and examines the validity of the digital certificate 2, thereby verifying the authenticity of the signer and that tampering has not been done.

Next, an operation of the digital signed document delivery system according to this embodiment will be described. First, the outline of the flow of overall processing will be described with reference to FIG. 2. As shown in FIG. 2, the bill data creating unit 5 creates data (see FIG. 3) that is necessary for bill creation. An operator sends this data to the server 20 and issues an instruction to perform signature processing. As a result of this processing, a digital bill (see FIG. 4) is automatically created by the digital bill creating unit 6 of the server 20 based on the data. During this processing, by checking the identity of the operator using a log-in password or the like at the operator-side terminal, it becomes possible to ensure a security level. Next, the digital signature unit 7 of the server 20 automatically performs digital signature processing on the created digital bill. When the digital signature processing is ended, the bill electronic delivery unit 9 of the server 20 transmits the digital bill to the customer side through a communication network 21 such as the Internet or an intranet. On the customer side on which the digital bill is received, the digital bill digital signature verification unit 11 verifies whether the digital bill has a digital signature affixed by an authentic signer and whether the digital bill has not been tampered. If a result of this verification is OK (affirmative), the bill processing unit 12 performs predetermined processing on the bill on the customer side.

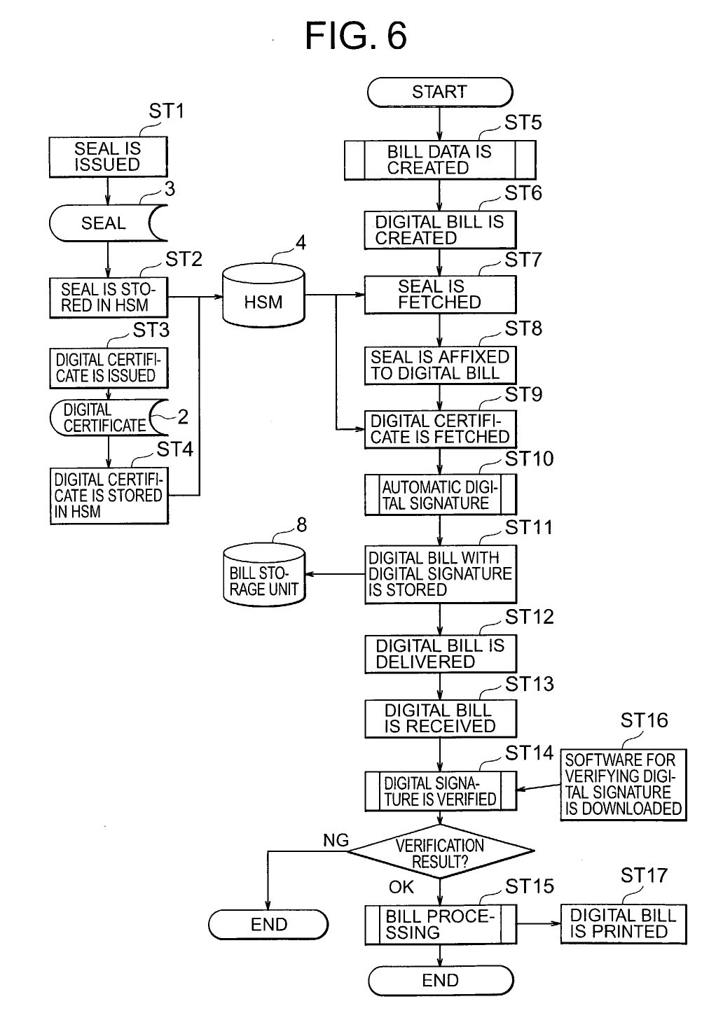

Next, processing for electronically delivering the bill will be described in more detail with reference to the flowchart shown in FIG. 6. First, in step ST1, there is created a seal to be affixed to digital data on which a signature should be placed at the time of digital signature processing. In step ST2, the seal created in step ST1 is stored in the HSM 4. In step ST3, the digital certificate 2 to be used to perform the digital signature processing is issued at the digital certificate issuing office 1. In step ST4, the digital certificate 2 issued in step ST3 is stored in the HSM 4. The processing until this step is a preparation for the digital signature processing. It is sufficient that this preparation be performed only once when an operator uses this system for the first time. When the operator uses this system again, the seal 3 and the digital certificate 2 stored in the HSM 4 are used.

First, in step ST5, source data of a bill is created. In step ST6, format data stored in the bill format storage means 14 is fetched and a digital bill is created based on the data created in step ST5. Note that it is possible to execute the processing in step ST5 in a system other than the server 20. In this case, the creation of the digital bill in step ST6 is performed through data connection. In step ST7, the seal 3 to be affixed to the digital bill is fetched from the HSM 4. In step ST8, the seal 3 fetched in step ST7 is affixed to the digital bill. In step ST9, the digital certificate 2 for placing a digital signature on the digital bill is extracted from the HSM 4. In step ST10, the digital signature is automatically placed on the digital bill using the digital certificate 2 extracted in step ST9. The digital signature is automatically placed, so that it becomes possible to process a large quantity of digital bills. In step ST11, the digital bill, on which the digital signature has been placed, is stored in the bill storage unit 8. In step ST12, the digital bill, on which the digital signature has been placed, is electronically delivered by e-mail, over the Web, or the like. Next, in step ST13, the digital bill is received on the customer side that is the destination of the bill. In step ST14, the digital signature placed on the digital bill is verified on the customer side. In the case where a result of this verification is NG, the processing is ended. On the other hand, if the verification result is OK, the processing proceeds to step ST15, in which bill processing is performed based on the digital bill. Unlike paper media, it is possible to extract data from the digital bill, which makes it possible to perform the bill processing through data connection with another system. Note that step ST16 is a step in which a program for executing the verification of the digital signature in step S14 is provided through downloading from the server 20. Step ST17 is a step in which there is performed printing of the digital bill. The seal is affixed to the digital bill, so that when the digital bill is printed in step ST17, it becomes possible to visually confirm the issuer of the bill in completely the same manner as in the case of a conventional paper bill. The processings in steps ST16 and ST17 are performed as necessary. Therefore, in comparison with a conventional case where paper is used, it becomes possible to reduce the number of works for printing each bill, putting the bill in an envelope, and affixing a postage stamp to the envelope, which contributes to reduction in envelope cost and mailing cost. Note that in the case where it is impossible to deliver the digital bill for any trouble, an error report may be automatically transmitted to the operator terminal from the server 20.

As has been described above, in this embodiment, the processing for creating a digital document using inputted data, performing digital signature processing for the digital document, and electronically delivering the processed digital document are automatically performed by the server 20 without the requirement for operations from an operator. As a result, in comparison with a conventional case where this processing is performed as manual works, it becomes possible to achieve significant processing load reduction, to deliver a large quantity of documents without difficulty, to realize labor cost reduction, to enhance efficiency, and to realize speedup. In addition, cost reduction is achieved because the envelope cost, mailing cost, and the like that have conventionally been required become unnecessary.

Also, as the input data that is used at the time of creation of a digital document, character strings based on CSV or the like are merely inputted. Therefore, in comparison with a conventional method in which data is inputted into predetermined spaces of a structured document that takes a form of a bill or the like, it becomes possible to reduce a load placed by the input work, to enhance efficiency, and to realize speedup.

Also, concurrently with the digital signature, a seal is affixed to a digital document, so that by printing the digital document (or displaying the document on a screen using an apparatus such as a PDF document reader), it becomes possible to visually confirm the issuer of the digital document in the same manner as in the case of a paper medium.

(Second Embodiment)

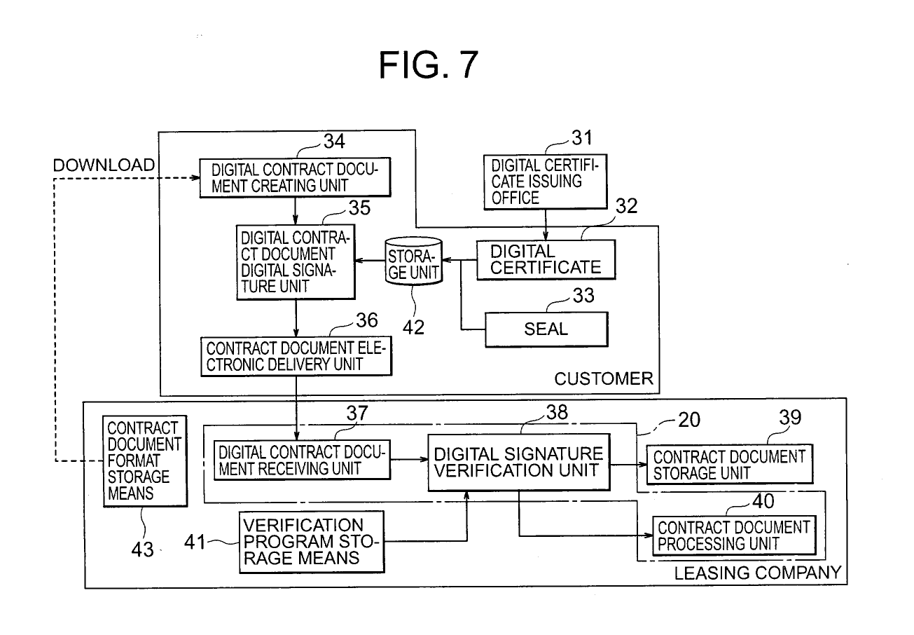

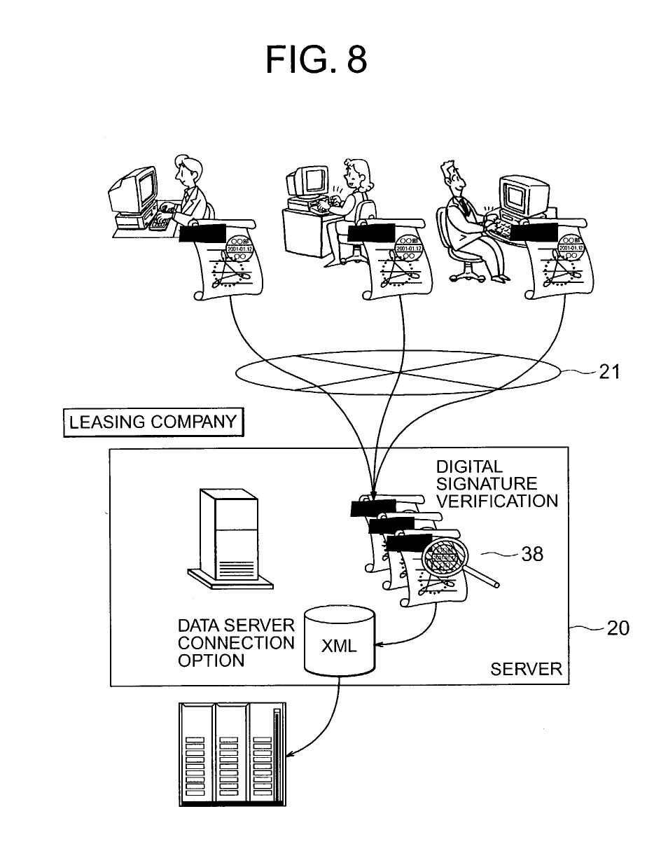

FIGS. 7 and 8 show the construction of a digital signed document delivery system according to a second embodiment of the present invention. In these drawings, a case where a contract document is issued by a leasing company is illustrated as an example. Also, in these drawings, the same construction elements are given the same reference numerals for the sake of clarifying correspondences. In FIG. 7, reference numeral 31 denotes a digital certificate issuing office that issues a digital certificate; 32, the digital certificate issued by the digital certificate issuing office 31; 33, a seal (or seal data) to be affixed to a digital contract document when digital signature processing is performed; 34, a digital contract document creating unit that creates a digital contract document; 35, a digital contract document digital signature unit that places a digital signature on the digital contract document created by the digital contract document creating unit 34; and 36, a contract document electronic delivery unit that electronically (by e-mail or over the Web) delivers the digital contract document on which the digital signature has been placed. Reference numeral 42 represents a storage unit in which the seal 33 and the digital certificate 32 are stored. This storage unit 42 may be constructed from a HSM. In this embodiment, however, the storage unit 42 is installed on the customer side, so that it is practical that this unit 42 is constructed from an IC card, a hard disk (HDD), or a similar component. Note that reference numerals 32 to 36 and 42 specify construction elements provided on the contractor (customer) side.

Reference numeral 37 indicates a digital contract document receiving unit that receives, on the leasing company side, the digital contract document electronically signed by and delivered from the customer; 38, a digital signature verification unit that automatically verifies the digital signature placed on the received digital contract document; 39, a contract document storage unit in which the digital contract document on which the digital signature has been placed is automatically stored; and 40, a contract document processing unit that performs contract procedure based on the contract document. Reference numeral 41 denotes a verification program storage means and reference numeral 43 represents a contract document format storage means provided on the leasing company side in which there is stored format data used at the time of creation of the digital contract document. When a contract document is created by the digital contract document creating unit 34 on the customer side, this format data is obtained with a method, such as downloading, and the contract document is created using the format data on the customer side. Note that reference numerals 37 to 41 and 43 specify construction elements provided on the leasing company side. Also, note that the digital contract document receiving unit 37, the digital signature verification unit 38, and the contract document processing unit 40 are constructed from the server 20 and each function thereof is operated by control from the server 20, which means that no operation from an operator is required.

An operation will be described. First, the outline of the flow of overall processing will be described with reference to FIG. 8. As shown in FIG. 8, on a side of at least one customer who wishes to conclude a leasing contract, the digital contract document creating unit 34 performs data input to complete a contract document, thereby creating a digital contract document. Note that the format of the digital contract document is obtained through downloading from the contract document format storage means 43 of the server 20 installed in the leasing company that is the other party of contract, for instance. Next, a digital signature is placed on the digital contract document by the digital contract document digital signature unit 35. The digital contract document, on which the digital signature has been placed, is transmitted to the leasing company by the contract document electronic delivery unit 36 through a communication network 21 such as the Internet or an intranet. At the leasing company, the digital signature verification unit 38 verifies whether the received digital contract document has been electronically signed by an authorized signer and has not been tampered. If a result of this verification is OK, predetermined processing is performed for the contract document by the contract document processing unit 40 on the leasing company side.

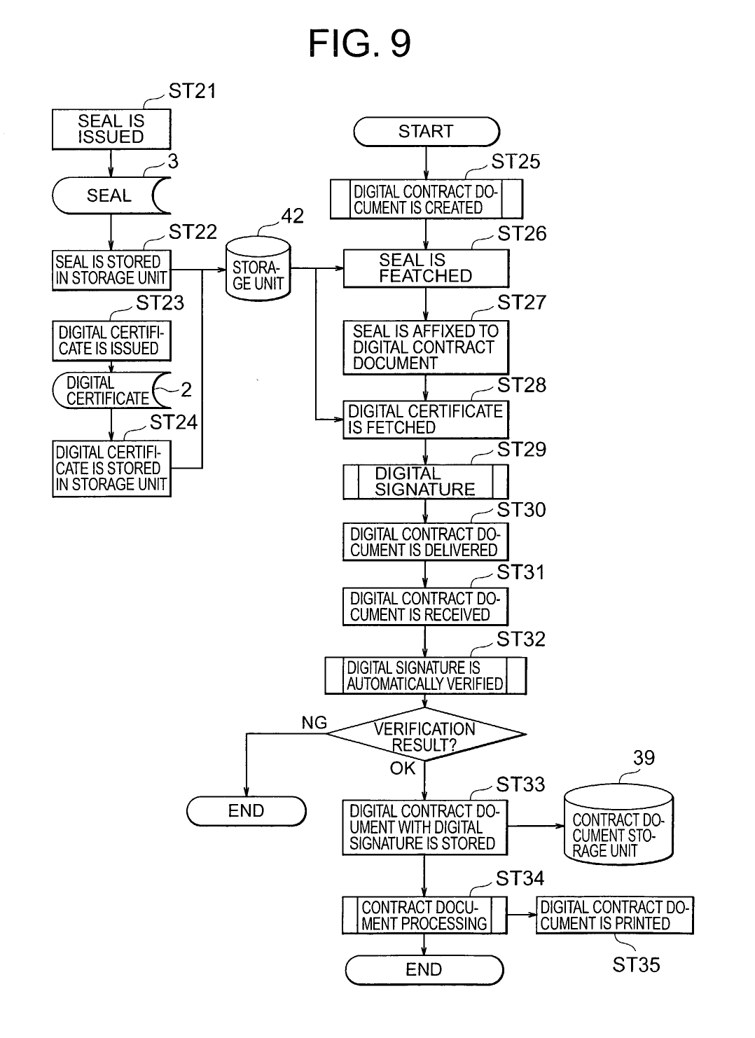

Next, processing for electronically delivering the digital contract document will be described in more detail with reference to the flowchart shown in FIG. 9. In step ST21, there is created a seal 33 to be affixed to digital data to be signed at the time of digital signature processing. In step ST22, the seal 33 created in step ST21 is stored in the storage unit (such as an IC card, a HDD, or an HSM) 42. In step ST23, a digital certificate 32 used to perform the digital signature processing is issued at the digital certificate issuing office 31. Next, in step ST24, the digital certificate issued in step ST23 is stored in the storage unit (such as an IC card or a HDD) 42. In step ST25, in order to create a digital contract document, digital contract format is downloaded. In step ST26, the seal 33 to be affixed to the digital contract document is fetched from the storage unit 42. In step ST27, the seal 33 fetched in step ST26 is affixed to the digital contract document. In step ST28, the digital certificate 32 for placing a digital signature on the digital contract document is fetched from the storage unit 42. In step ST 29, a digital signature is placed on the digital contract document using the digital certificate 32 fetched in step ST 28. In step ST30, the digital contract document, on which the digital signature has been placed, is electronically delivered by mail or over the Web. Accordingly, it becomes possible to reduce costs for printing a contract document, putting the contract document in an envelope, and mailing the envelope, in comparison with a conventional case where paper is used. In step ST 31, the digital contract document, on which the digital signature has been placed, is received by the server on a contract document receiving side. In step ST32, the digital signature placed on the digital contract document is automatically verified. The verification of the digital signature is automatically performed, so that it becomes possible to process a large quantity of digital contract documents. In the case where a result of this verification is NG, the processing is ended. In step ST33, the digital contract document, on which the digital signature has been placed, is stored. In step ST34, contract processing is performed based on the digital contract document. It is possible to extract data from the digital contract document, so that it is also possible to perform the contract processing through data connection with another system. In step ST35, printing of the digital contract document is performed. A seal has been affixed to the digital contract document, so that as a result of this printing, it becomes possible to visually confirm the other party of contract like in a conventional case where a paper contract document is used. Note that a notification of whether the contract has been concluded or not may be automatically issued to the customer by the server 20.

As has been described above, in this embodiment, contract documents transmitted from a plurality of customers are received by the server and the contract documents are processed after the server automatically performs verification without the requirement for operations from an operator. As a result, in comparison with a conventional case where contract documents printed on paper media are received by mail and the processing described above is performed through manual works, it becomes possible to achieve significant processing load reduction, to perform verification and processing of documents that are delivered from a plurality of customers in high volume without difficulty, to realize labor cost reduction, to enhance efficiency, and to realize speedup. Further, it becomes possible to realize cost reduction because a work for inputting data from a paper medium and a mailing cost that have conventionally been required become unnecessary. In particular, at the time of conclusion of a contract or the like, a time taken to mail a contract document is significantly shortened in comparison with a conventional case where paper medium is mailed, so that it becomes possible to speed up (expedite) contract procedure, to provide more convenience, and to enhance efficiency of business operations.

Also, concurrently with the digital signature, a seal is affixed to a digital document, so that by printing the digital document (or displaying the document on a screen using an apparatus such as a PDF document reader or the like), it becomes possible to visually determine the issuer of the digital document in the same manner as in the case of a paper medium.

Note that in the second embodiment described above, a case where a leasing contract with a leasing company is concluded has been described as an example. As a matter of course, however, the present invention is not limited to this case and it is possible to apply the present invention to issuance and delivery of all of contract documents concerning various kinds of contracts such as a purchase contract with a sales company that sells a predetermined commodity (such as various kinds of goods, books, clothes, or the like), an insurance contract with an insurance company, and various kinds of usage contracts regarding a telephone bill or the like.

(Third Embodiment)

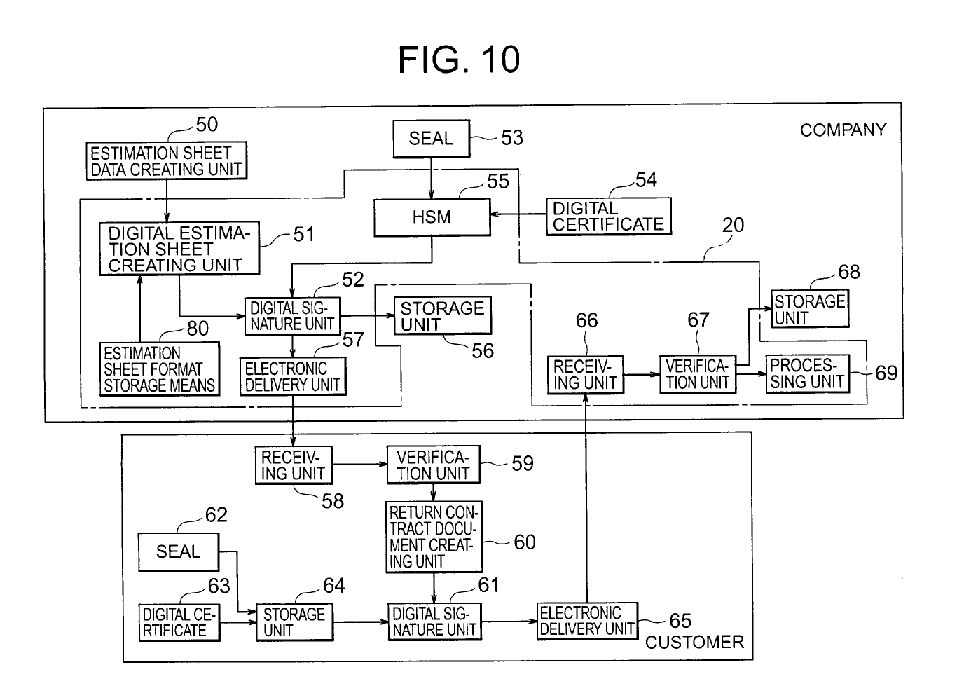

FIG. 10 shows the construction of a digital signed document delivery system according to a third embodiment of the present invention. In this embodiment, the first and second embodiments described above are combined with each other. Note that in this embodiment, a case where a company sends an estimation sheet to a customer will be described as an example. When the customer consents to the contents of the estimation sheet, he/she creates a contract document based on the estimation sheet, and returns the contract document to the company. In FIG. 10, reference numeral 50 denotes an estimation sheet data creating unit that creates estimation sheet data composed of a set of character strings; 51, a digital estimation sheet creating unit that creates a digital estimation sheet from the estimation sheet data; 52, a digital signature unit (on a company side) that performs digital signature processing; 53, a seal (on the company side) ; 54, a digital certificate (on the company side); 55, an HSM (on the company side) in which the seal 53 and the digital certificate 54 are stored; 56, a storage unit in which a digital estimation sheet subjected to the digital signature processing is stored; and 57, a electronic delivery unit (on the company side) that digitalally delivers the estimation sheet. Reference numeral 80 represents an estimation sheet format storage means in which format data for the digital estimation sheet is stored.

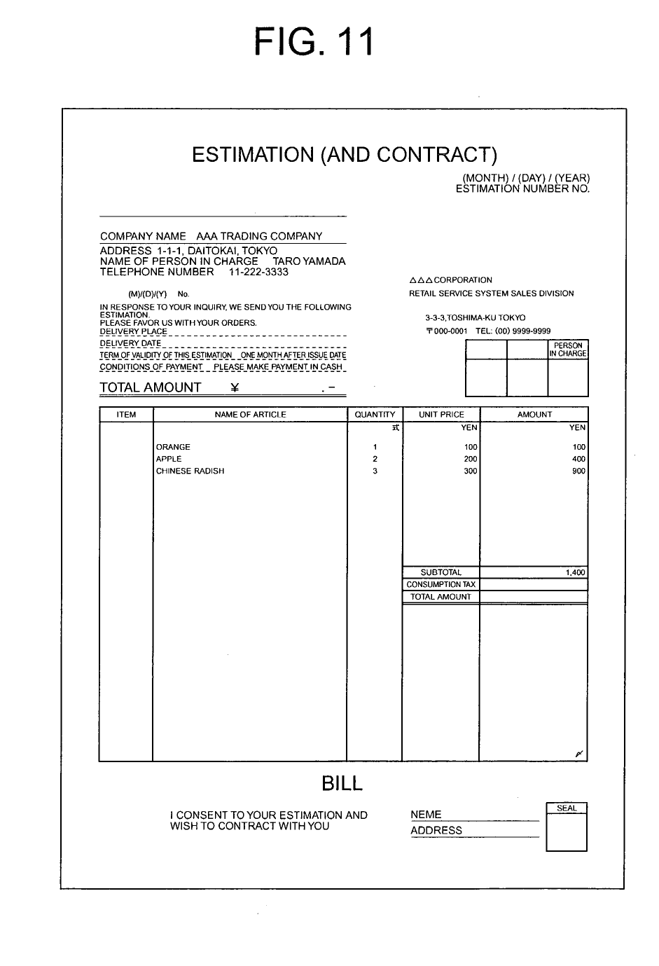

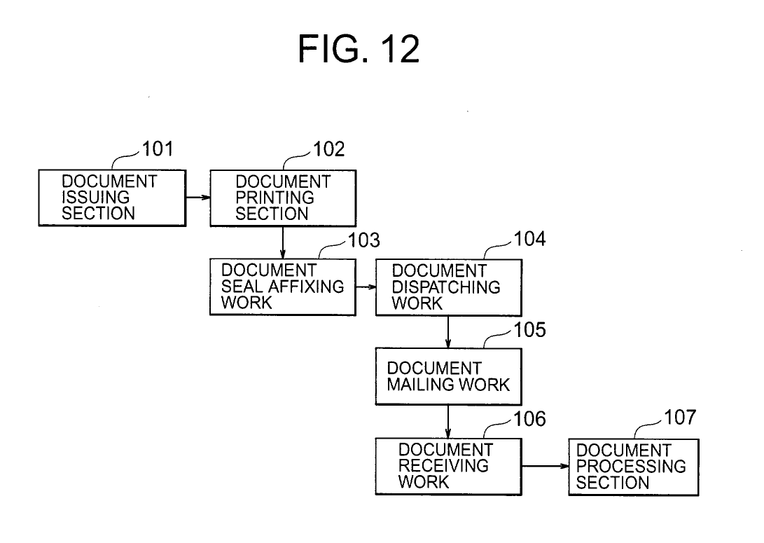

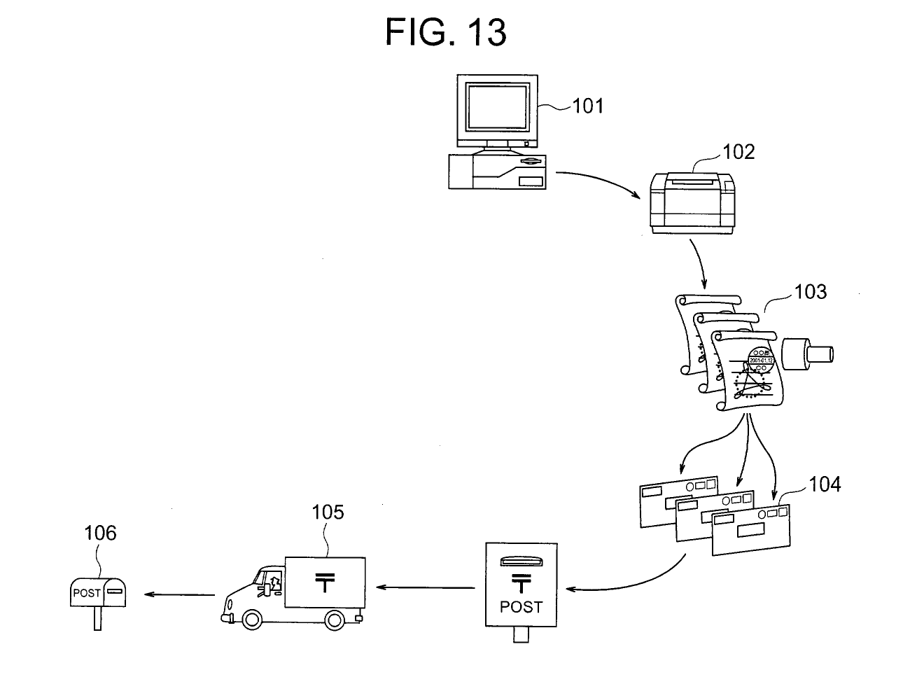

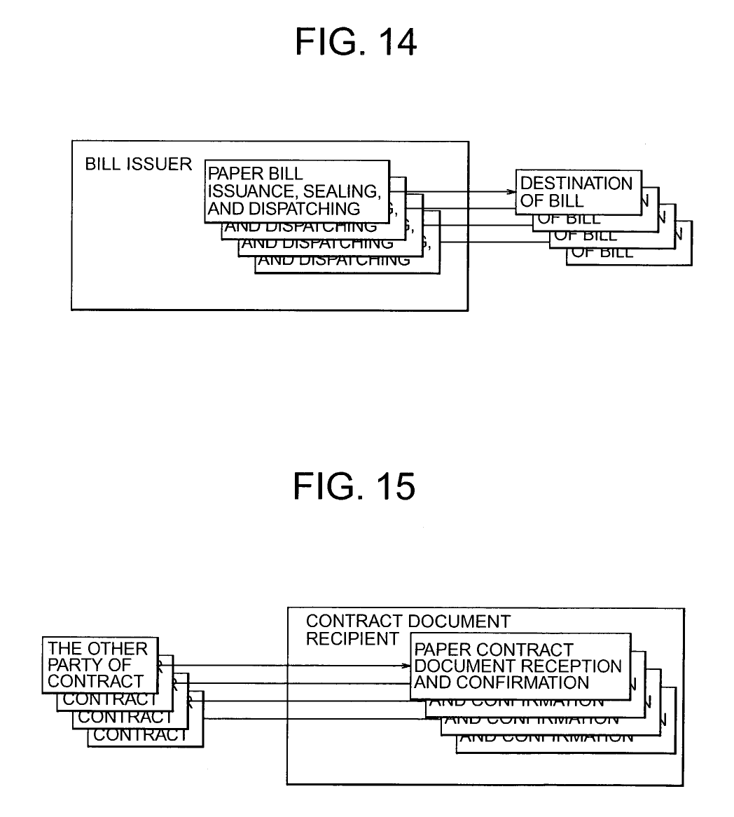

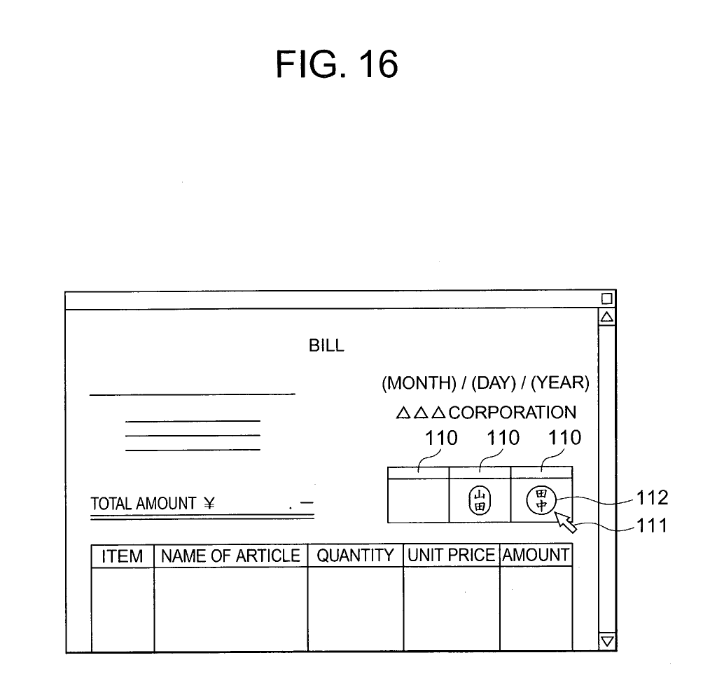

Reference numeral 58 denotes a receiving unit (on a customer side) that receives the delivered digital estimation sheet and numeral 59 represents a verification unit (on the customer side) that verifies the authenticity of the digital signature on the received digital estimation sheet. Reference numeral 60 indicates a return contract document creating unit that, in the case where a result of the verification by the verification unit 59 is affirmative, receives input of necessary data from the customer into a contract document provided in a lower portion of the digital estimation sheet, thereby creating a return digital contract document, as shown in FIG. 11. Reference numeral 61 denotes a digital signature unit (on the customer side) that places a digital signature on the created digital contract document; 62, a seal (on the customer side); 63, a digital certificate (on the customer side); 64, a storage unit which is constructed from an IC card, an HDD, or the like and in which there is stored the seal 62 and the digital certificate 63; and 65, a electronic delivery unit that electronically delivers the digital contract document. Note that reference numerals 58 to 65 specify construction elements provided on the customer side.

Reference numeral 66 denotes a receiving unit (on the company side) that receives the delivered digital contract document; 67, a verification unit (on the company side) that verifies the received digital contract document; 68, a storage unit in which there is stored the verified digital contract document; and 69, a processing unit that processes the verified digital contract document.

It should be noted here that reference numerals 50 to 57, 66 to 69, and 80 specify construction elements provided on the company side. Also, note that the digital estimation sheet creating unit 51, the digital signature unit 52, the HSM 55, the electronic delivery unit 57, the receiving unit 66, the verification unit 67, the processing unit 69, and the estimation sheet format storage means 80 are constructed from the server 20 and each function thereof is operated by control from the server 20, which means that no operation from an operator is required.

An operation will be briefly described. The details thereof are the same as those in the first and second embodiments described above and thus, will be understood with reference to the embodiments. First, estimation sheet data (see FIG. 3) composed of a set of character strings is created by the estimation sheet data creating unit 50. Next, an estimation sheet is created by the digital estimation sheet creating unit 51 based on the estimation sheet data, is subjected to digital signature processing by the digital signature unit 52, and is delivered by the electronic delivery unit 57 to the customer. On the customer side, this estimation sheet is received by the receiving unit 58 and is verified by the verification unit 59. If the customer consents to the contents of the estimation sheet, necessary data, such as his/her address and name, is inputted by the return contract document creating unit 60 into the contract document (see FIG. 11) provided in the lower portion of the estimation sheet, thereby creating a return contract document. Next, this return contract document is subjected to digital signature processing by the digital signature unit 61 and is returned by the electronic delivery unit 65 to the company side.

The returned contract document is received by the receiving unit 66, is verified by the verification unit 67, is stored in the storage unit 68, and is processed by the processing unit 69.

As has been described above, in this embodiment, the creation of a digital document to be delivered to a customer, the placing of a digital signature onto the digital document, and the delivery of the digital signed document are automatically performed by the sever on the company side. Also, on the customer side, the reception of the digital signed document, the verification of the received digital signed document, and the returning of a digital document are automatically performed by the server on the customer side. Further, the server on the company side automatically receives the electronic document returned from the customer, verifies the received digital document, and processes the verified digital document. As a result, it is possible to obtain the same effects as in the first and second embodiments described above.

It should be noted here that the present invention is applicable to all kinds of important documents that require signatures, in addition to a bill, a contract document, and an estimation sheet (and a contract document).

It should be noted here that needless to say, there is ordinarily obtained a construction where digital information for realizing each function and performing each processing described above (that is, program codes and data) is stored in an internal or external storage device of each computer apparatus that is not shown in the drawings, and is read and executed as occasion arises. Note that it is possible to implement the present invention if it is possible to achieve the function for realizing each processing described above in each computer apparatus. Therefore, for instance, the digital information may be recorded on a transportable recording medium, such as a CD-ROM or an FD, that is separable from each computer apparatus or recorded in a program server or the like connected to a network, be read at the time of usage, be recorded in an internal or external storage device of the computer apparatus, and be executed as occasion arises.

(Fourth Embodiment)

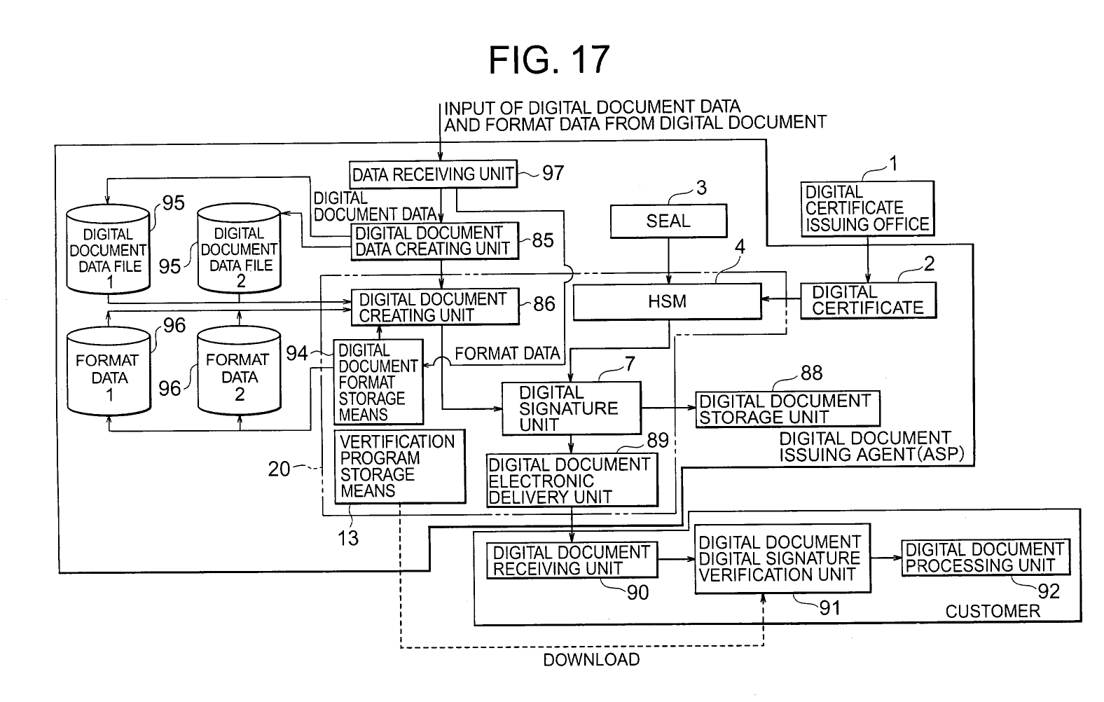

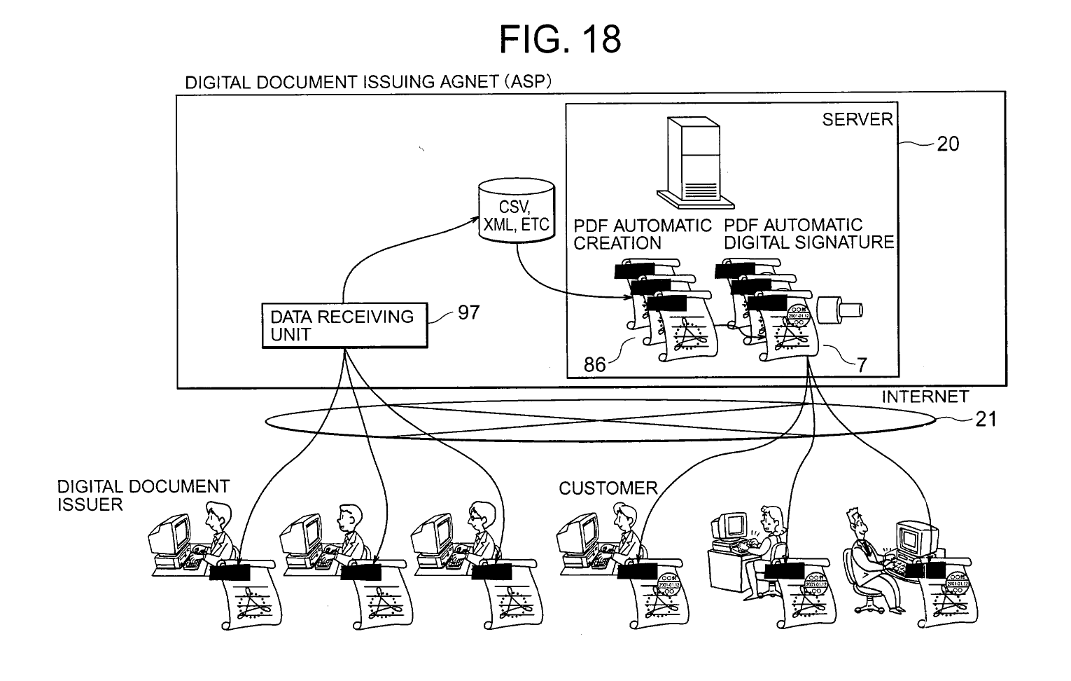

FIGS. 17 and 18 show the construction of a digital signed document delivery system according to a fourth embodiment of the present invention. In the first embodiment described above, there is obtained a construction where a bill is delivered. In this embodiment, however, there is obtained a construction where various kinds of digital signed documents are delivered. Also, in these drawings, the same constructions as in FIGS. 1 and 2 related to the first embodiment are illustrated using the same reference numerals for the sake of clarifying correspondences.

As shown in FIG. 18, in this embodiment, for instance, a digital document issuing agent that is an ASP operator receives requests to issue digital documents from a plurality of digital document issuers, and transmits the digital documents to a plurality of customers corresponding to the digital documents based on the requests. The reception of requests from the digital document issuers and transmission of the digital documents to corresponding customers are carried out through a communication network 21 such as the Internet. By implementing this embodiment in this manner, the ASP operator can receive digital document issuance requests from a plurality of digital document issuers and also transmit digital documents in formats, which correspond to the requests from the digital document issuers, to corresponding customers.

As examples of the digital documents, it is possible to cite the digital bill shown in FIG. 4, the digital estimation sheet shown in FIG. 11, a payment notification, a transfer notification, and the like. Also, in the case of a digital bill, the format thereof generally varies depending on the digital document issuer of the digital bill. However, the format is received as format data in advance, so that it is possible to transmit digital documents in formats, which correspond to wishes of digital document issuers, to customers.

In FIG. 17, construction elements denoted by reference numerals 1 to 4 and 13 are the same as those described in the first embodiment. Note that in this embodiment, the digital certificate 2 and the seal 3 are generally possessed by each digital document issuer and, when a digital document issuance request is received from the digital document issuer for the first time, the digital certificate 2 and the seal 3 are generated. Also, depending on the kind of a digital document, it is possible to construct the digital document using the digital certificate 2 and the seal 3 of the digital document issuing agent.

Reference numeral 97 denotes a data receiving unit that receives digital document data and format data from a digital document issuer as a digital document issuance request. Reference numeral 85 represents a digital document data creating unit and reference numeral 95 indicates a digital document data file. The digital document data creating unit 85 creates various kinds of data necessary for creation of a digital document based on the digital document data received by the data receiving unit 97 and stores the created data as a digital document data file 95. Reference numeral 94 represents a digital document format storage means and reference numeral 96 indicates the format data. The digital document format storage means 94 creates the format data 96 based on format data received by the data receiving unit 97 and stores the created format data 96.

The digital document data file 95 is, for instance, the digital bill data shown in FIG. 3 and contains data that specifies the digital document issuer (a company name, an address, and the like, for instance) and delivery destination information (mail address, for instance) of a customer to whom the digital document should be delivered. Also, in the format data 96, there is registered a format corresponding to the issuance request from the digital document issuer. In more detail, there is registered the digital bill format shown in FIG. 4, for instance. Further, the digital document data file 95 and the format data 96 are paired with each other, so that each of them is given a correspondence number or the like and the correspondence between them is maintained by this correspondence number.

Reference numeral 86 denotes a digital document creating unit that creates a digital document from the digital document data file 95 and the format data 96. Reference numeral 7 represents a digital signature unit that performs digital signature processing by encrypting the digital document created by the digital document creating unit 86 using a secret key possessed by a signer. Reference numeral 88 indicates a digital document storage unit in which the digital document, on which a digital signature has been placed by the digital signature unit 7 is stored, and reference numeral 89 denotes a digital document electronic delivery unit that electronically delivers the digital document on which the digital signature has been placed by the digital signature unit 7. Here, the data receiving unit 97, the digital document data creating unit 85, the digital document creating unit 86, the digital signature unit 7, the digital document storage unit 88, and the digital document electronic delivery unit 89 are constructed from the server 20 and each function thereof is operated by control from the server 20, as has been described in the first embodiment.

Further, in FIG. 17, reference numeral 90 denotes a digital document receiving unit that receives the digital signed document delivered to the customer side; 91, a digital document digital signature verification unit that verifies the digital signature placed on the digital document using a downloaded verification program; and 92, a digital document processing unit that performs digital document processing based on the digital document. Reference numerals 90 to 92 are construction elements provided on the customer side on which the digital document is received.

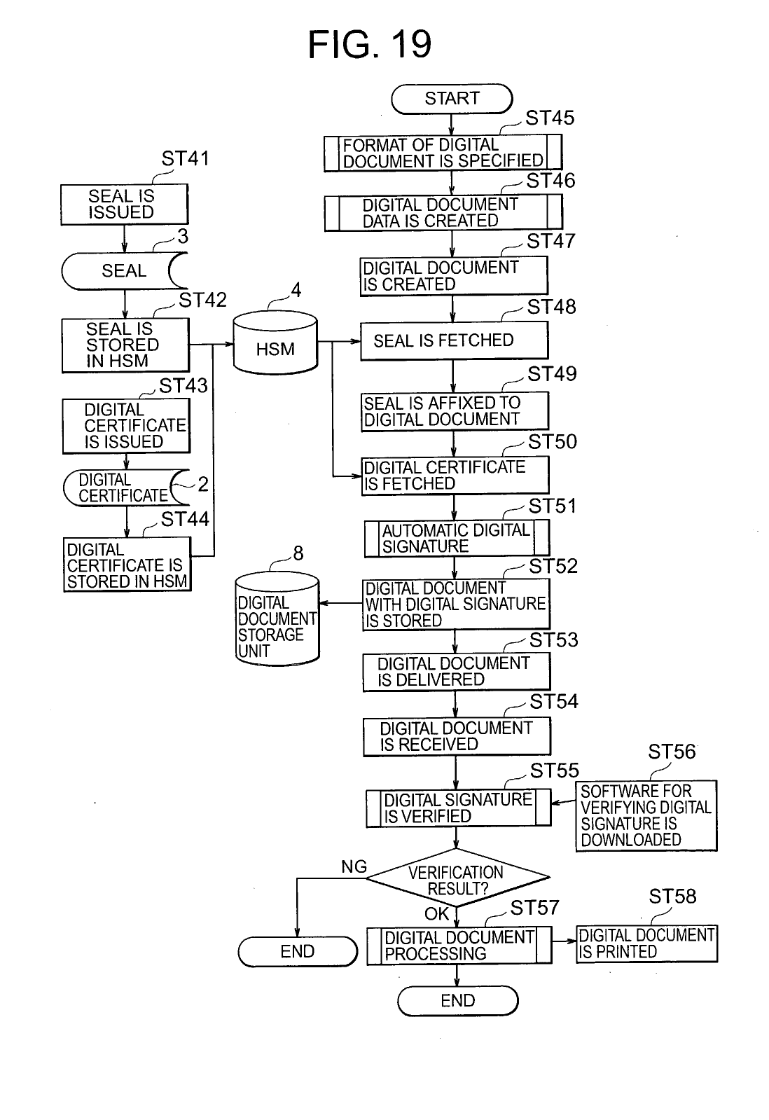

Next, processing for electronically delivering the digital document will be described in detail with reference to a flowchart shown in FIG. 19. In FIG. 19, in steps ST41 to ST44, there is performed the same processing as in steps ST1 to ST4 in the flowchart shown in FIG. 6. During this processing, as has been described above, the digital certificate 2 is issued to each digital document issuer, so that steps ST41 to ST44 are executed when a request to issue a digital document is received from a digital document issuer for the first time.

In step ST45, there is designated a format of a digital document to be delivered and processing for delivering the digital document is performed in the succeeding steps ST46 to ST58. Processing in steps ST46 to ST58 is the same as the processing in steps ST5 to ST17 in the flowchart shown in FIG. 6. In this embodiment, however, the processing for delivering a digital bill performed in steps ST5 to ST17 is changed to processing for delivering the digital document specified in step ST45. When a digital document to be delivered is specified in step ST45, it is possible to perform this specifying so that a specific digital is to be delivered in a predetermined time period or a digital document corresponding to a specific digital document issuer or customer is to be delivered in a specific time period. Further, there may be obtained a construction where a menu screen, through which a digital document is to be selected, is displayed on a display screen (not shown) of a terminal connected to the server 20. In this case, a digital document is selected from the menu.

As has been described above, in this embodiment, there is obtained a construction where a digital document issuing agent (ASP operator, for instance) receives digital document issuance requests from a plurality of digital document issuers and digital documents that respectively correspond to the plurality of customers are transmitted based on the requests. With this construction, it becomes possible for the ASP operator to receive digital document issuance requests from a plurality of digital document issuers and to transmit digital documents in formats corresponding to the requests from the digital document issuers to corresponding customers. Also, the format of a digital bill generally varies depending on the digital document issuer of the digital bill. In this embodiment, however, the format is received as format data in advance, so that it becomes possible to transmit a digital document in a format corresponding to the wish of each digital document issuer to a customer.

(Fifth Embodiment)

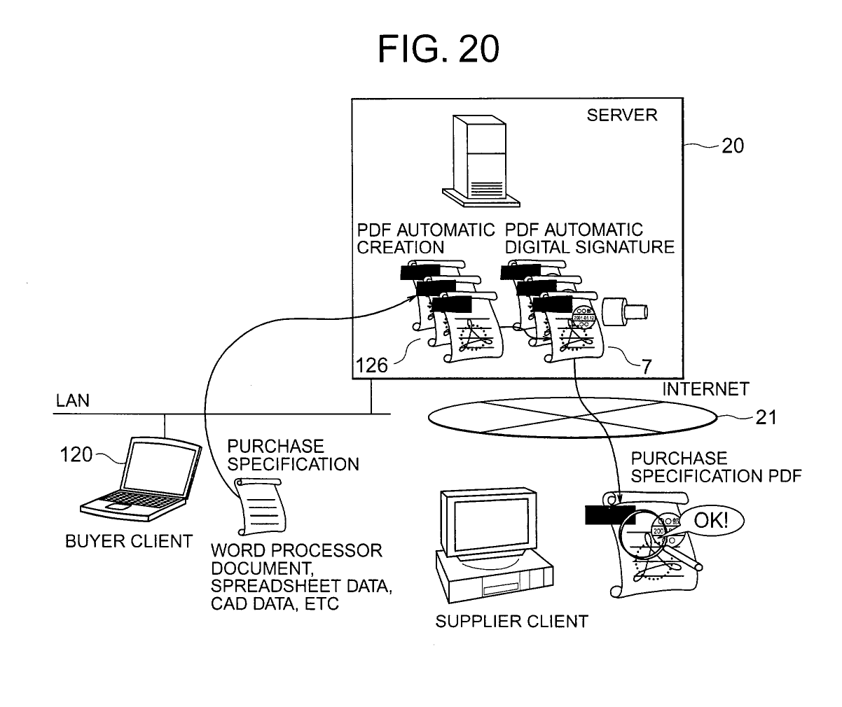

FIG. 20 shows the outline of a digital signed document delivery system according to a fifth embodiment of the present invention. In this embodiment, the construction of the system in the first or fourth embodiment that delivers a digital bill or a digital document is changed to a construction in which it is possible to additionally deliver a document that becomes necessary in a transitory manner. As such a document that becomes necessary in a transitory manner, it is possible to cite purchase specifications or technical specifications, for instance. It is possible to individually receive a word processor document, spreadsheet data, CAD data, and the like from a terminal 120 connected to the server 20 and to deliver them as digital documents. Also, like in the fourth embodiment, when the present system is constructed as an ASP, it is possible to individually receive documents from digital document issuers and to deliver them as digital documents.

As has been described above, in this embodiment, the delivery of documents that have been individually received are embedded into the digital document delivery system that delivers digital documents in a constant manner, so that it also becomes possible to ensure the authenticity of a document that becomes necessary in a transitory manner.

(Sixth Embodiment)

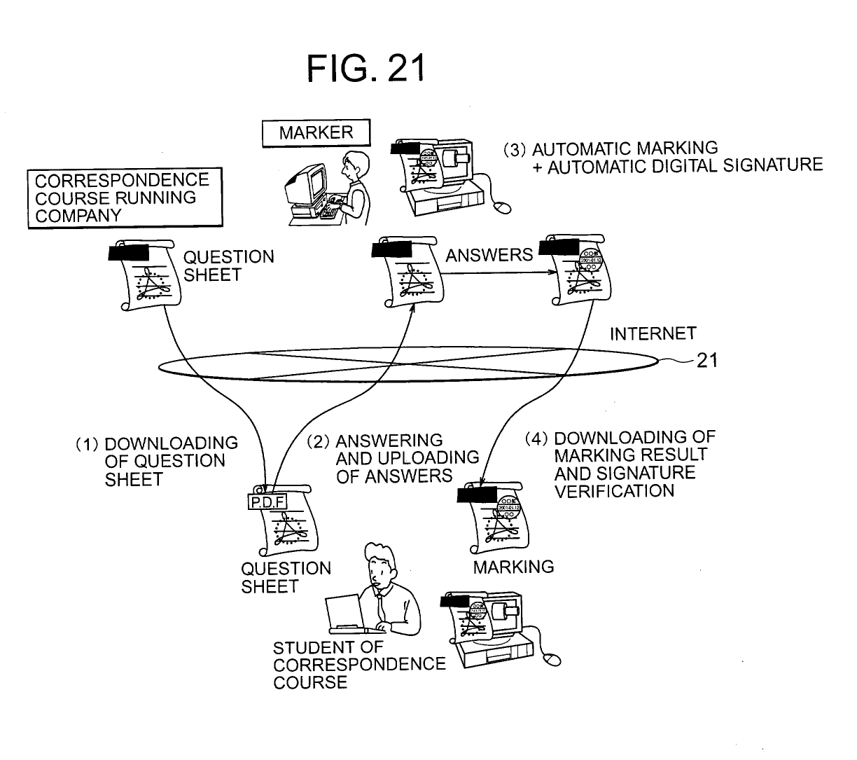

FIG. 21 shows the outline of a digital signed document delivery system according to the sixth embodiment of the present invention. In this embodiment, there will be discussed processing where questions of a correspondence course are delivered from a company or the like, which is a digital document issuer and runs the correspondence course, to a student of the correspondence course that is a customer. Then, answers of the customer are received by the digital document issuer. In the case of a correspondence course, it is possible to conceive that data transmission and reception are performed several times between the correspondence course running company and the customer in the correspondence course. In this embodiment, however, as shown in FIG. 21, there are performed (1) the downloading of questions (processing on a customer side), (2) the uploading of answers (processing on the customer side), (3) automatic marking and digital signature processing (processing on a correspondence course running company side), and (4) the downloading of a result of the marking and signature verification (processing on the customer side).

As has been described above, in this embodiment, even in the case where data transmission and reception are performed several times between a digital document issuer and a customer like in the case of the correspondence course running company, it becomes possible to perform the data transmission and reception while ensuring authenticity of the data as a digital document. Also, if the questions are constructed in a PDF format, for instance, it becomes possible to specify answer fields, which makes it possible for a marker on the correspondence course running company side to automatically mark answers.

With the present invention, there are provided a digital signed document delivery system, a digital signed document delivery method, and a digital signed document delivery program by which document creation data composed of character strings is inputted, a digital document is created using the document creation data, digital signature processing is performed for the created digital document to create digital signature data, and the digital document and the digital signature data are combined with each other and are electronically delivered. Also, there is provided a recording medium in which the digital signed document delivery program is recorded. As a result, it becomes possible to realize work load reduction and cost reduction.

What is claimed is:

1. A digital signed document delivery system comprising:
a document creation data input means for inputting document creation data composed of character strings;
a digital document creating means for creating a digital document using the document creation data;
a digital signature means for creating digital signature data by performing digital signature processing on the created digital document; and
a document delivery means for combining the digital document and the digital signature data and electronically delivering them.

2. A digital signed document delivery system according to claim 1, further comprising:
a format data storage means for storing format data for creating the digital document,
wherein the digital document creating means creates the digital document based on the format data.

3. A digital signed document delivery system according to claim 1, further comprising:
a verification program storage means in which a verification program that verifies the delivered digital signature data is stored,
wherein the verification program is provided to a recipient side through a communication network.

4. A digital signed document delivery system according to claim 1, wherein:
the digital signature processing is performed using a predetermined secret key and a predetermined digital seal; and
the secret key and the digital seal are stored in a tamper-resistant recording means.

5. A digital signed document delivery system according to claim 1, further comprising:
a document receiving means for receiving the delivered digital document and digital signature data;
a verification means for verifying authenticity of the received digital signature data using the verification program;
a return document creating means for, if a result of the verification by the verification means is affirmative, creating a return digital document using the digital document;
a return digital signature means for creating return digital signature data by performing digital signature processing on the created return digital document; and
a document returning means for combining the return digital document and the return digital signature data and electronically delivering them.

6. A digital signed document delivery system according to claim 5, further comprising:
a return document receiving means for receiving the delivered return digital document and return digital signature data; and
a verification means for verifying the received return digital signature data.

7. A digital signed document delivery system comprising:
at least one delivery means for combining a digital document and digital signature data obtained by performing digital signature processing on the digital document, and delivering them;
a receiving means for receiving the digital document and the digital signature data delivered by the delivery means;
a verification means for verifying the received digital signature data; and
a verification program storage means in which a verification program for performing the verification by the verification means is stored.

8. A digital signed document delivery method comprising:
a document creation data input step of inputting document creation data composed of character strings;
a digital document creating step of creating a digital document using the document creation data;
a digital signature step of creating digital signature data by performing digital signature processing on the created digital document; and
a document delivery step of combining the digital document and the digital signature data and electronically delivering them.

9. A digital signed document delivery method comprising:
at least one delivery step of combining a digital document and digital signature data obtained by performing digital signature processing on the digital document, and delivering them;
a receiving step of receiving the digital document and the digital signature data delivered by the delivery step;
a verification step of verifying the received digital signature data; and
a verification program storage step in which a verification program for performing the verification by the verification step is stored.

10. A digital signed document delivery program used for allowing a computer to execute:
a document creation data input step of inputting document creation data composed of character strings;
a digital document creating step of creating a digital document using the document creation data;
a digital signature step of creating digital signature data by performing digital signature processing on the created digital document; and
a document delivery step of combining the digital document and the digital signature data and electronically delivering them.

11. A digital signed document delivery program used for allowing a computer to execute:
at least one delivery step of combining a digital document and digital signature data obtained by performing digital signature processing on the digital document, and delivering them;
a receiving step of receiving the digital document and the digital signature data delivered by the delivery step;
a verification step of verifying the received digital signature data; and
a verification program storage step in which a verification program for performing the verification by the verification step is stored.

12. A computer readable recording medium that records a digital signed document delivery program used for allowing a computer to execute:
a document creation data input step of inputting document creation data composed of character strings;
a digital document creating step of creating a digital document using the document creation data;
a digital signature step of creating digital signature data by performing digital signature processing on the created digital document; and
a document delivery step of combining the digital document and the digital signature data and electronically delivering them.

13. A computer readable recording medium that records a digital signed document delivery program used for allowing a computer to execute:
at least one delivery step of combining a digital document and digital signature data obtained by performing digital signature processing on the digital document, and delivering them;
a receiving step of receiving the digital document and the digital signature data delivered by the delivery step;
a verification step of verifying the received digital signature data; and
a verification program storage step in which a verification program for performing the verification by the verification step is stored.

14. A digital signed document delivery system according to claim 2, further comprising:
a data receiving unit that receives a digital document issuance request, digital document data concerning a digital document, and format data concerning the digital document from at least one digital document issuer, wherein:
the format data storage means stores the format data received by the data receiving unit as a format data file; and
the document creation data input means stores the digital document data received by the data receiving unit as a digital document data file.
